(19) United States
(12) Patent Application Publication
(10) Pub. No.: US 2024/0245011 A1
(43) Pub. Date: Jul. 25, 2024

(54) CULTIVATION SYSTEM AND METHOD

(71) Applicant: Burnette Consulting, Inc., Tallahassee, FL (US)

(72) Inventor: John T. Burnette, Pensacola, FL (US)

(21) Appl. No.: 18/100,867

(22) Filed: Jan. 24, 2023

(51) Int. Cl. A01G 9/14; A01G 7/00; A01G 9/02

(52) U.S. Cl. CPC A01G 9/143; A01G 7/00; A01G 9/023

(57) ABSTRACT

A system and method for reducing condensation in the indoor cultivation of photoperiodic plants. The cultivation system includes a day room, a night room, and preferably a control area in between. The control area in the preferred embodiments acts as a “light lock” between the day room and the night room. The artificial lighting in the day room remains on and the night room remains dark. Alternating periods of lights and dark are provided for the plants by physically transporting them from the day room to the night room and back again. An automated conveyor system preferably provides the transportation. The plants are sent through the control area when passing between the day room and the night room. The control area prevents light leakage so that the plants within the night room are not exposed to any significant light from the day room.

### CROSS-REFERENCES TO RELATED APPLICATIONS

Not applicable

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

### 1. Field of the Invention

This invention relates to the field of plant cultivation. More specifically, the invention comprises a cultivation system and method configured to provide periods of light and dark while reducing the formation of condensation.

### 2. Description of the Related Art

This invention relates particularly to the cultivation of photoperiodic flowering plants. Such plants require periods of light and dark to grow, and further require variations in the duration of these periods in order to promote flowering.

Photoperiodic plants are generally classified as short-day, long-day, and day-neutral. This terminology was developed at a time when the length of daylight was thought to be critical to the plant's development. It was later discovered that the length of night was actually the critical factor. Photoperiodic flowering plants are still classified primarily as long-day plants or short-day plants—even though the length of the night is the critical factor.

Long-day plants flower when the length of the night falls below a critical interval. These plants typically flower during late spring or early summer as nights are getting shorter. Short-day plants flower when the length of night exceeds a critical interval. Short-day plants typically flower in the late summer or fall as nights grow longer significantly; the time of darkness must be uninterrupted. Short-day plants will not typically flower if a pulse of artificial light is shone on the plant for even several minutes during the night. They require a continuous period of darkness before floral development can begin (Natural moonlight or starlight is not bright enough to interfere with the flowering process).

The cultivation of crops outdoors depends upon the natural cycles of daylight and darkness. Short-day plants will thus only flower with the approach of fall. This limits production to one flowering cycle per year. On the other hand, indoor production of crops can continue year-round. From the preceding description of photoperiodism, however, the reader will understand that indoor cultivation requires proper control of the lighting.

A maximum growth rate and minimum harvest cycle is desirable for most plant production. Thus, an indoor grower wants to maximize the time when light is provided to the growing plants. This is tempered, however, by the constraints of photoperiodism. The light requirements vary with the stages of the growing cycle. The growing cycle is generally thought of as (1) the seed germination stage, (2) the seedling stage, (3) the vegetative stage, and (4) the flowering stage.

Seed germination is often bypassed by using a cutting to create a new plant (sometimes referred to as “cloning”). Once the seedling stage is reached, the plants are placed in an indoor growth facility where they will remain until harvested. For a short-day plant, the time periods involved in the growing cycle are typically as follows:
(1) Seedling stage—2 to 3 weeks with 16 hours of light in a day;
(2) Vegetative stage—3 to 16 weeks with 16 hours of light in a day;
(3) Flowering stage—8 to 11 weeks with 12 hours of light in a day (and 12 hours of darkness, with the increasing length of darkness triggering the flowering cycle).

Using indoor cultivation it is possible to obtain three or four harvests per year—even from slow-growing plants. Exemplary short-day plants include Hops (Humulus lupulus), Soybeans (Glycine max), Rice (Oryza), Cotton (Gossypium), Hemp (Cannabis sativa), and Cannabis (Cannabis sativa and Cannabis indica). Low-value crops are generally of little interest for indoor cultivation. This is because the environmental control costs (light, humidity, and temperature) are higher for indoor cultivation. However, the systems and methods disclosed in the present inventions are applicable to most any type of crop and should not be viewed as limited to short-day plants or high-value plants that are commonly grown indoors.

In prior art indoor cultivation rooms, the plants are grown in containers arrayed beneath banks of overhead lights. The lights are switched on for the day phase and switched off for the night phase. The cultivation room is typically shielded from outside light so that the periods of lights and dark can be controlled as desired. Environmental control systems can be used to regulate air circulation, temperature, and humidity. However, the use of environmental control raises production costs and the growers therefore seek to minimize the use of such controls.

Indoor cultivation requires a regular transition from the day phase (when the overhead lights are on) to the night phase (when the overhead lights are off). The transition to the night phase inevitably causes a temperature drop in the growing room. This temperature drop poses a significant risk to the health of the plants, particularly where the relative humidity is fairly high.

The air in a growing room has a relatively fixed content of water vapor. This is often expressed as relative humidity—which is a measure of the partial pressure of the water vapor found in the air to the maximum partial pressure of water vapor that the air can hold (also known as the saturation point) for a given temperature. As the temperature of the room drops, the relative humidity rises. This is true because the mass of water vapor in the air remains fixed but the maximum mass of water vapor the air can hold decreases with decreasing temperature.

The “dew point” refers to the temperature to which the air must be cooled to reach the saturation point—given the mass of water vapor that is present. If the air temperature within the growing room falls to the dew point, condensation will form on the plants. Entrapped moisture on plants causes fungal growth, such as Botrytis. Floral buds are particularly susceptible, as these contain a mostly enclosed volume that will tend to retain any condensed moisture. More mature flowers are also susceptible, since they still contain dense structures that tend to funnel condensation forming on leaves and other structures into an enclosed volume.

Unwanted condensation is a well known and pervasive problem in the field of indoor plant cultivation. This is particularly true for areas where the mean ambient relative humidity is above 60 percent—such as the eastern half of the United States. The prior art approach is to use HVAC units (heating, ventilation, and air conditioning, including related or supplemental humidity control) to maintain the temperature above the dew point during the night phase and/or remove water vapor from the air in the grow room. Obviously, this approach increases the cost of production.

The present invention reduces condensation in the indoor cultivation of photoperiodic plants. This objective is achieved without the need for significantly increased environmental control costs.

### BRIEF SUMMARY OF THE INVENTION

The present invention comprises a system and method for reducing condensation in the indoor cultivation of photoperiodic plants. The cultivation system includes a day room, a night room, and preferably a control area in between. The control area in the preferred embodiments acts as a “light lock” between the day room and the night room. The artificial lighting in the day room remains on and the night room remains dark. Alternating periods of lights and dark are provided for the plants by physically transporting them from the day room to the night room and back again. An automated conveyor system preferably provides the transportation. The plants are sent through the control area when passing between the day room and the night room. The control area prevents light leakage so that the plants within the night room are not exposed to significant light from the day room.

### BRIEF DESCRIPTION OF THE SEVERAL VIEWS OF THE DRAWINGS

FIG. 1 is a plan view, showing a cultivation system according to the present invention.

FIG. 2 is a plan view, showing the system of FIG. 1 in operation.

FIG. 3 is a plan view, showing the system of FIG. 1 in operation.

FIG. 4 is a plan view, showing the system of FIG. 1 in operation.

FIG. 5 is a perspective view, showing the use of the conveyor system to move plant racks.

FIG. 6 is an elevation view, showing internal features of the system of FIG. 1.

### REFERENCE NUMERALS IN THE DRAWINGS

10 cultivation house
12 day room
14 night room
16 control area
18 plant rack
20 conveyor system
22 wall
24 wall
26 wall
28 wall
30 wall
32 wall
34 wall
36 door
38 door
40 second light-blocking door
42 first light-blocking door
44 third light-blocking door
46 fourth light-blocking door
48 HVAC system
50 HVAC system
52 HVAC system
54 grow pot
55 trolley
56 plant
57 trolley
58 partition
60 longitudinal track set
62 longitudinal track set
64 lateral track set
66 lateral transfer actuator
68 lateral actuator track
70 plant rack
72 plant rack
74 plant rack
76 plant rack
78 stop
80 stop
82 foundation
84 roof
86 door drive
88 door drive
90 control system

### DETAILED DESCRIPTION OF THE INVENTION

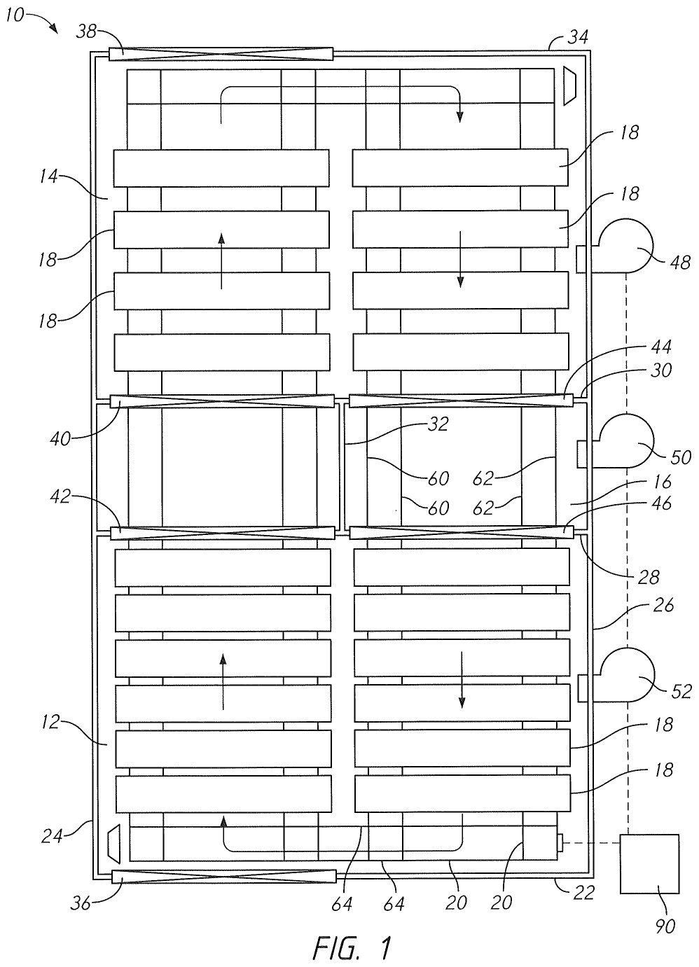

The inventive method can be carried out using a wide variety of physical structures, and the invention is not limited to any particular structure. Thus, the embodiments disclosed in FIGS. 1-6 should properly be viewed as exemplary and should not be viewed as limiting.

FIG. 1 provides a plan view of a cultivation house 10 configured to practice the present invention. The exemplary elongated cultivation house is contained within walls 22, 24, 26, and 34. An overhead roof structure is provided so that the cultivation house is shielded from the surrounding environment. The roof structure is conventional and so it has not been illustrated. The interior of the cultivation house is shielded from ambient lighting (though it is possible to use sunlight brought into the enclosure during periods where natural sunlight coincides with the day phase of the growth cycle conducted within the cultivation house).

Exterior doors 36, 38 are provided so that materials can be transported into and out of the cultivation house. Seedlings are often transported into the cultivation house from a separate facility through one or both of these doors. Harvested plants are likewise taken out of the house through these doors 36, 38.

Cultivation house 10 contains day room 12 and night room 14. The day and night rooms are separate by control area 16. In the example shown, control area 16 is physically segregated from the day and night rooms. Transverse wall 28 separates control area 16 from day room 12. Transverse wall 30 separates control area 16 from night room 14. The use of the two hard walls to define the control area is exemplary. In other embodiments a single wall my be used and in other embodiments this wall may be mobile and temporary.

The present invention can be operated in a variety of ways. However, it will be advantageous—and therefore common—to maximize the throughput of the system. In that case day room 12 and night room 14 will be operated continuously. The light will be on continuously in the day room. Likewise, night room 14 will be operated continuously in darkness.

The use of the term “continuously” should not be viewed as an absolute. Obviously there may be a period of power interruption in the day room. Likewise, there may be a period where the lights in the day room are switched off for maintenance or bulb replacement. Likewise, light may need to be furnished in the night room to perform maintenance or repairs. A continuously light day room in this context means that the lights in the day room will be on during normal operations. A continuously dark night room in this context means that the light level in the night room is kept low enough during normal operations to not interfere with the photoperiodic night phase of the plants being grown. Thus, the night room might have a faint light source on the order of natural moonlight that is switched on from time to time or left on.

The reader will thus understand that in the present inventive scheme the day room is light and the night room is dark. The photoperiodic needs of the plants being cultivated are satisfied by transporting the plants from the day room to the night room and back again in a regular cycle. This cyclic transportation can be accomplished in a variety of ways. In the example shown in FIG. 1, the plants are grown in a set of elongated plant racks 18. These plant racks 18 are moved automatically by conveyor system 20.

The tracks of the exemplary conveyor system 20 are in the form of a rectangle. The tracks transport the plant racks in a clockwise loop—indicated by the arrows in FIG. 1. The loop passes from day room 12, through control area 16, through night room 14, back through control area 16, and back into day room 12. Control system 90 preferably controls the operation of the conveyor system and other systems within cultivation house 10. The control system periodically cycles the conveyor to move plant racks 18 from the day phase to the night phase and back again. Control system 90 preferably contains one or more processors and an associated memory that stores software to be run. A programmable logic controller may be used for this purpose. A more sophisticated mini computer may be used as well.

As explained previously, it is important for the night phase of many photoperiodic plants to not be exposed to light for more than a short interval. It is therefore important when moving the plants not to let significant light from the day room penetrate the night room. There are several approaches to solving the problem of light contamination. FIG. 1 shows a preferred approach. In this example, conveyor system 20 moves plant racks 18 in a clockwise loop around the cultivation house (The direction is arbitrary). Sets of doors are provided in walls 28, 30. When a plant rack is proceeding from the day room into control area 16, it first passes through first light blocking door 42 and into control area 16. In order to pass from control area 16 into night room 14 the plant rack passes through second light blocking door 40. The plant rack then travels around a half-loop within night room 14.

The same plant rack 18 passes back into control area 16 by passing through third light blocking door 44. It then passes out of control area 16 and back into day room 12 by passing through fourth light blocking door 46. All four light blocking doors 40,42,44,46 are shown in a closed state—as indicated by the “X” on each in the view. When closed, each light blocking door does not allow any significant passage of light. However, each light blocking door can be opened when desired—preferably under the control of control system 90. The reader will also note that longitudinal wall 32 optionally divides control area 16 into two portions. The advantage of this optional division will be explained subsequently.

The preferred operation of the light blocking doors will be explained with respect to the travel of a pair of plant racks. With respect to FIG. 1, consider the two plant racks presently just outside of first light blocking door 42 in day room 12. Consider also the two plant racks just outside of third light blocking door 44 in night room 14.

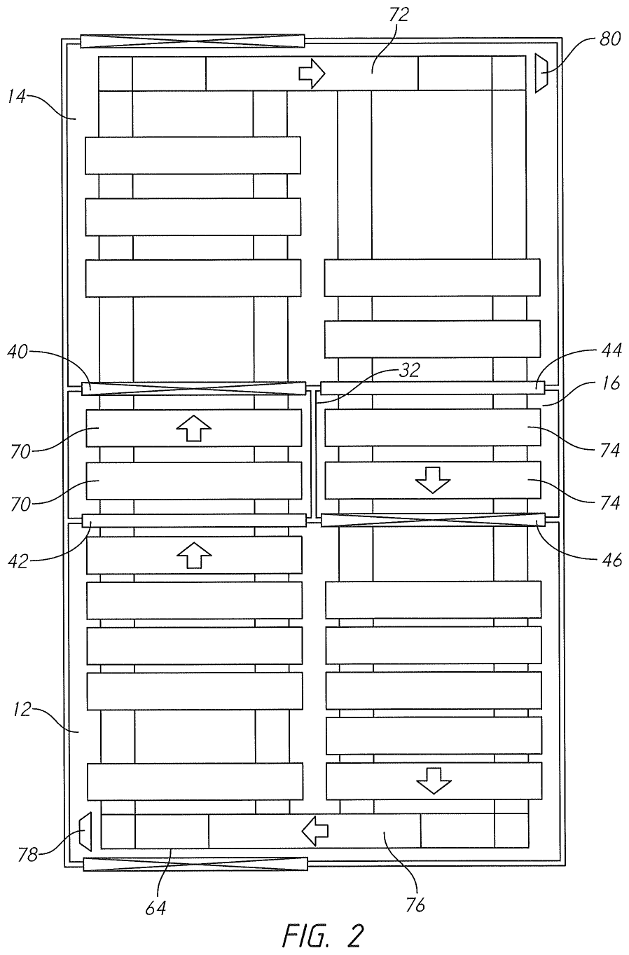

In FIG. 2, first light blocking door 42 and third light blocking door 44 have been opened—while second light blocking door 40 and fourth light blocking door 46 remain closed (The closed doors show an “X” in the view and the open doors have no “X.”). The conveyor system has been activated to move all the plant racks in a clockwise direction around the conveyor loop. Thus, two plant racks 70 have been moved from day room 12 into control area 16 (to the left of wall 32 in the view). Two plant racks 74 have also been moved from night room 74 into control area 16 (to the right of wall 32 in the view).

In this embodiment the conveyor system “indexes” all the plant racks around the loop. In the day room, lateral track 64 is used to transfer plant rack 76 to the left an onto the portion of the conveyor loop that is heading toward the control area. In the night room, plant rack 72 is being transferred to the right so that it will then also lie on the portion of the conveyor loop that is heading toward the control area. Lateral stops 78,80 stop the lateral transfer of the plant racks in the right position to be reengaged by a longitudinal portion of the conveyor system.

FIG. 2 serves to illustrate the light blocking attributes of control area 16. Control area 16 is unlighted during the transfer in this embodiment. In the configuration of FIG. 2, light comes from day room 12 through open door 42 and into the portion of control area 16 lying to the left of wall 32. However, this light does not pass into night room 14 since second light blocking door 40 remains closed. Door 44 is also open, but this only connects night room 14 to the right side of the control area. Door 46 remains closed and no light enters the right side of the control area (to the right of wall 32).

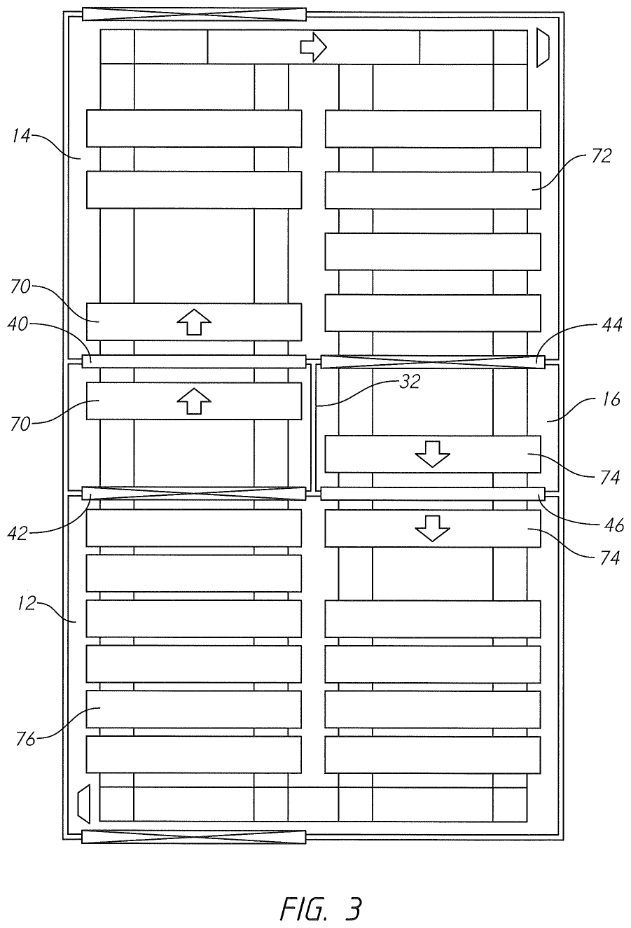

Once plant racks 70, 74 are positioned as shown, doors 42, 44 are again closed (so that all four doors leading to the control area 16 are closed). FIG. 3 shows the next step in the process. Second light blocking door 40 and fourth light blocking door 46 are opened. The conveyor system is then activated to move plant racks 70 through open door 40 and into night room 14. The conveyor system is also activated to move plant racks 74 through open door 46 and into day room 42.

At this point light from day room 12 comes in through open door 46 and into the right side of control area 16. However, third light blocking door 44 remains closed and prevents any light entering night room 14. Wall 32 prevents light leaking laterally into the left side of control area 16 and into the night room through open door 40. Thus, the four light blocking doors leading into control area 16 operate as a “light lock” that prevents light leakage into night room 14 while the plant racks are transferred through. The presence of wall 32 allows both sides of the light lock to be operated simultaneously, and this increases the overall transit speed around the loop of the conveyor. Wall 32 does not need to be a rigid wall and can in fact be a light-limiting curtain or other light-blocking device. For some species and configurations wall 32 will not be necessary. In its absence some light does leak through, but this is indirect light and indirect light is dim enough to not interfere with photoperiodism for some plant species. Thus, wall 32 is optional.

After plant racks 70 have been moved into night room 14 and plant racks 74 have been moved into day room 12, all four light blocking doors 40,42,44,46 are again closed. The same process of “locking through” plant racks can be repeated as desired. Using this process, every plant rack can be circulated around the loop and thereby provided with a suitable night phase and day phase.

The size of the control area in relation to the day room and night room is somewhat arbitrary. However, in the example of FIGS. 1-4 the control area is sized to receive two plant racks at a time during the transfer process.

Returning to FIG. 1, some additional features will be described. HVAC systems may be supplied for one or more compartments of the cultivation house 10. In the example shown, HVAC system 48 is provided for night room 14. HVAC system 50 is provided for control area 16. HVAC system 52 is provided for day room 12. In this context the term HVAC system should be viewed broadly to encompass anything that tends to control air circulation, air temperature, or air humidity. Thus, under the term “HVAC” is included circulation fans, dehumidifiers, humidifiers, heaters, air conditioners, heat pumps and the like.

The requirements for HVAC systems will depend upon many factors, with the ambient environment—the environment outside of the cultivation house—being an important one. Growers will naturally wish to minimize HVAC costs. Day room 12 will often require greater temperature control because of the heat generating properties of the lighting. Night room 14 will tend to need less environmental control.

Having said that, a significant advantage presented by the present invention is the ability to maintain the night room at a fairly steady temperature. This regulated temperature should be above the dew point of the air in the night room. The temperature in the night room is preferably also at or below the temperature of the day room. This condition minimizes the formation of condensation on the plants as they are transferred from the day room into the night room. A plant traveling from the day room into the night room is entering an environment where the temperature is above the dew point and at or below the temperature of the plant itself (which will have assumed the temperature of the day room by that point, or nearly so).

The configuration of the overall system will often be driven by the temperature needed in the day room. One can maintain a constant temperature year-round. However, for locations with a seasonal variation in outside temperature, it will be desirable to allow some variation in the conditions within the cultivation house to maximize overall efficiency by minimizing HVAC costs. As an example—in wintertime the day room can be maintained at 60 degrees Fahrenheit (15 degrees Celsius) with a relative humidity of 50%. To achieve this condition HVAC system 52 will typically have to provide some heat in addition to that provided by the grow lights in the day room. In addition, HVAC system 52 will often have to add humidity (in addition to the humidification provided as a by-product of watering the growing plants).

Also, in winter time, night room 14 can be maintained at 55 degrees Fahrenheit (13 degrees Celsius) with a relative humidity of 40%. Even though the night room is cooler than the day room, the night room temperature is held steady and held above the dew point. In these conditions condensation will not form on the plants as they are transferred into the night room.

In summertime the day room can be maintained at 90 degrees Fahrenheit (32 degrees Celsius) with 80% relative humidity. In a hot and humid ambient environment air conditioning and dehumidification will be required to achieve this day room environment (air conditioning also generally provides dehumidification). The night room in this period can also be maintained at 90 degrees Fahrenheit with 80% relative humidity. The cooling load for the night room will be less than the day room due to the lack of lighting.

The environment within control area 16 is preferably also controlled in terms of temperature and humidity. In some embodiments the control area will not need environmental regulation apart from the night and day rooms but in other embodiments it will. In looking at FIG. 1 the reader should note that HVAC systems 48,50,52 need not be three separate systems and in fact may be two systems or only one unified system. In fact, a single unified system will often be used for a large cultivation house. In such a system, an industrial HVAC system may be used. Such systems often use circulating hot and cold water—in a “hot loop” and a “cold loop”—to provide heating and cooling to different zones as necessary.

The reader should also note that the temperature and humidity within the day and night rooms can be allowed to “float” within a range of acceptable values. These will vary according to the crop being grown. As an example, the night room temperature can be allowed to vary so long as it always remains above the dew point of the air contained within the night room. To that end, environmental sensors are preferably provided throughout the various rooms of the cultivation house. These can be monitored by control system 90, with the control system providing activation of the HVAC system(s) to maintain the conditions in the desired range.

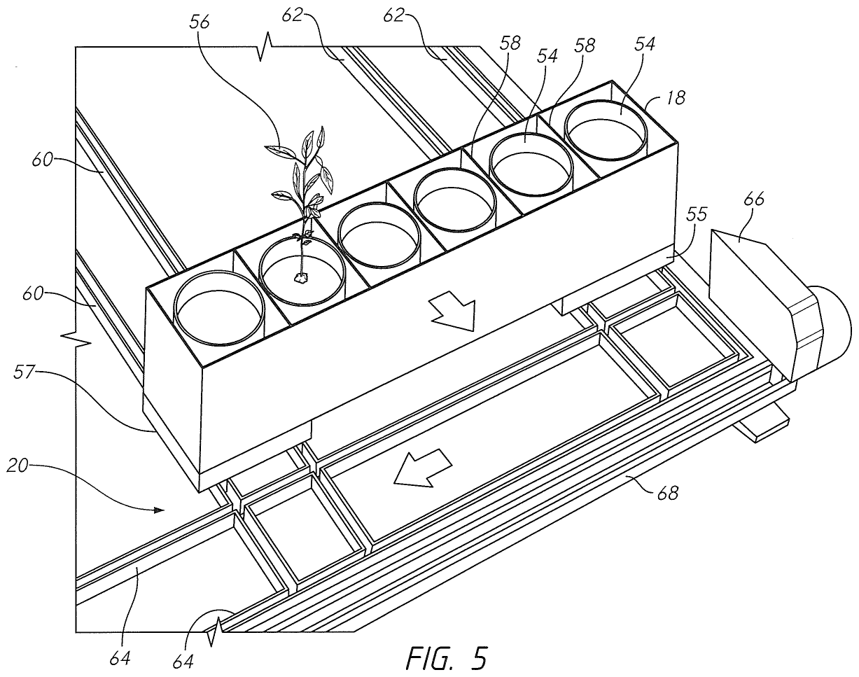

Some additional details of preferred embodiments will now be described. As stated previously a conveyor system is preferably provided to convey the plants in a loop between the day room and the night room. FIG. 5 depicts an exemplary conveyor system 20. The portion shown corresponds to the lower right-hand portion depicted in the plan view of FIG. 1.

Each plant rack 18 in this example includes a series of partitions 58 that divide the plant rack into a series of chambers sized to receive a grow pot 54. Each grow pot 54 houses one or more plants 56 to be cultivated. The right end of plant rack 18 (from the vantage point of the viewer in FIG. 5) rests on trolley 55 and the left end rests on trolley 57. Trolley 55 engages with longitudinal track set 62 and trolley 57 engages with longitudinal track set 60.

Longitudinal track sets 60,62 include moving chain segments within the tracks that engage descending lugs on trolleys 55,57. The chain segments can be selectively activated to move each plant rack 18 through a small distance, or all the chain segments along one “run” can be activated to move trolleys 55,57 over an extended distance.

Looking at FIG. 1, the reader will recall that the conveyor system in this example moves the plant racks around a clockwise loop. Longitudinal tracks 60,62 thus convey plant racks 18 away from wall 34 and toward wall 22. However, when a particular plant rack reaches the end of longitudinal tracks 60,62 it must be moved laterally (to the left in the view of FIG. 1). Lateral tracks 64 are provided for this purpose.

Returning now to FIG. 5, the reader will observe how lateral tracks 64 intersect with longitudinal tracks 60,62. In this example the chain drives within the longitudinal tracks propel trolleys 55, 57 until plant rack 18 rests in front of lateral transfer actuator 66. The lateral transfer actuator is then activated. This is a moving block that propels the trolleys 55, 57 laterally (see lateral arrow) while the lugs descending from the trolleys ride within lateral track 64. The lateral transfer actuator continues this motion until plant rack 18 comes to rest against stop 78. FIG. 2 shows this lateral motion and stop 78.

A lateral transfer actuator is also provided in the night room. FIG. 2 shows both lateral transfer actuators in operation. In FIG. 2 plant rack 76 is propelled to the left until it comes to rest against stop 78. Plant rack 72 is propelled to the right until is comes to rest against stop 80. Once against the stops the plant racks can be engaged and moved by the chain drives again. These lateral transfers can take place while the conveyor system is moving other plant racks along the longitudinal tracks.

Those skilled in the art will realize that the conveyor arrangement thus described is only one example among many, many possibilities. The present invention is not limited to any particular conveyor system. In fact, the conveyor system could simply be the provision of casters on the plant racks and the use of workers to push the mobile plants around the loop at the right time.

The inventive growth system should regulate the time each plant spends in the day room and the night room. During the vegetative stage a typical plant will need 16 hours of light and only 8 hours of darkness. The reader should bear in mind that the two separate rooms (one day room and one night room) are continuously “on.” Thus, during the vegetative stage it will be common to have more plant racks in the day room than in the night room at any given time. FIG. 1 shows this configuration.

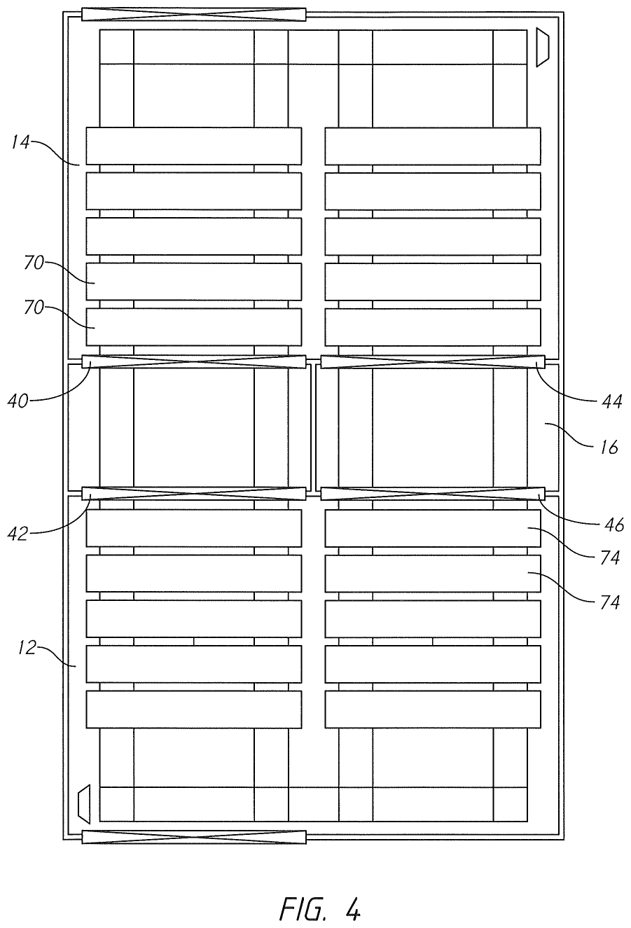

During the flowering stage the night phase must be extended. In this stage, as an example, the system can set 12 hours in the day room and 12 hours in the night room for each plant rack. It will then be common to have equal numbers of plants in the day room and in the night room. This configuration is shown in FIG. 4.

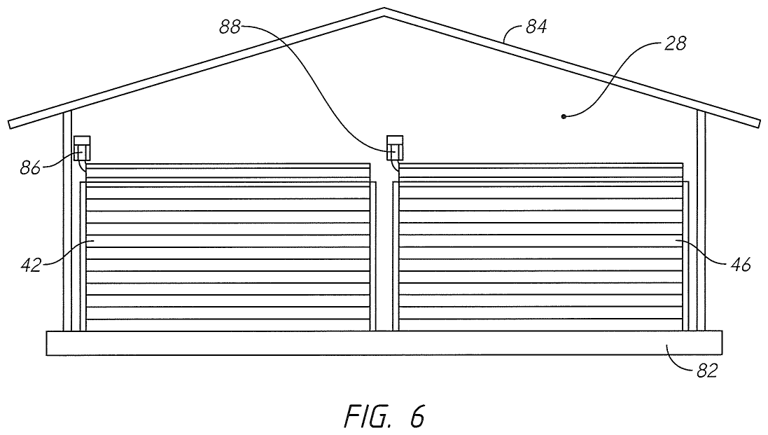

The light blocking doors can assume many forms. FIG. 6 shows an embodiment of such doors. FIG. 6 is an elevation view through the cultivation house taken just outside of wall 28. The light blocking doors in this case are industrial roll-up doors 42,46. Door drive 86 (an electric gear motor) raises and lowers light blocking door 42 under the command of the control system. Door drive 88 provides the same function for light blocking door 46. Lateral light gaskets are provided on the sides and top of each door. The bottom of each door seals against foundation 82.

The light seals need not be perfect. As explained previously, photoperiodic plants can tolerate some ambient lighting in the night phase (roughly equivalent to the amount produced by natural moonlight). Pinhole light leaks or even misaligned gaskets do not tend to let this level of light into the night room.

The reader will thereby perceive a significant advantage of the present invention. The lighting is not switched on and off to create the required day phase and night phase. Instead, a separate day room and night room are provided. The day room is always on (meaning light) and the night room is always on (meaning dark). This fact allows the temperature within the night room to remain steady. The steady temperature in the night room greatly reduces the formation of condensation on the plants and the consequent disease processes.

As explained previously, it is important for the night phase of many photoperiodic plants to not be exposed to light for more than a short interval. It is therefore important when moving the plants not to let light from the day room penetrate the night room. There are several approaches to solving the problem of light contamination. A first approach is simply to turn off the lights in the day room while the contents of the day room and the night room are swapped. This approach is possible, but the cycling of the light source in the day room tends to reduce the lifespan of the lighting elements.

A second approach is to open the light barrier(s) between the day room and the night room at a time when the entire contents of the day room is being moved to the night room and the entire contents of the night room is being moved to the day room. This allows light from the day room into the night room but only as the plants residing in the night phase were being brought into the day phase anyway. The drawback of this approach is that the whole inventory has to be swapped from night to day at one time.

The preferred approach uses the four light blocking doors to produce a “light lock” as shown in FIGS. 1-3. This allows the plant racks to be moved at any desired time without concern for light leakage.

Many additional variations and features will occur to those skilled in the art. These include:
(1) The growth cycle need not be based on a 24 hour day. Some plant species can tolerate an accelerated growth day;
(2) The conveyor system used can be belt-type conveyors. The conveyor system can even include an autonomous vehicle carrying each plant or plant rack;
(3) The light blocking doors need not be included in rigid walls. Instead light blocking curtains could be used;
(4) If the doors and conveyor system are fast enough, the light lock concept is not needed for some plant species. This is because the interval of light leaking through is short enough that it does not interfere with the plant's exposure to the night phase; and
(5) The control system can be provided with one or more processors, an associated memory, and wireless and/or wired external communications equipment. This will allow automatically programmed operation and remote monitoring.

The preceding description contains significant detail regarding the novel aspects of the present invention. They should not be construed, however, as limiting the scope of the invention but rather as providing illustrations of the preferred embodiments of the invention. Thus, the scope of the invention should be fixed by the following claims, rather than by the examples given.

What is claimed is:

1. A method for cultivating photoperiodic plants needing a day phase and a night phase, comprising:
(a) providing a day room with artificial light that is continually on;
(b) providing a night room that is continually dark;
(c) providing a control area between said day room and said night room, said control area including a first light-blocking door;
(d) providing a plurality of plant racks, with each plant rack containing some of said plants;
(e) providing a conveyor system configured to move said plant racks from said day room, through said control area, into said night room, back through said control area, and into said day room again;
(f) maintaining a first group of said plant racks in said day room for said day phase, while a second group of said plant racks is maintained in said night room for said night phase; and
(g) using said conveyor system to move said first group of plant racks from said day room to said night room and said second group of said plant racks from said night room to said day room.

2. The method for cultivating photoperiodic plants as recited in claim 1, comprising:
(a) providing said control area with a first wall separating said control area from said day room, said first wall having said first light-blocking door;
(b) providing said control area with a second wall separating said control area from said night room, said second wall having a second light-blocking door;
(c) opening said first light-blocking door only when said second light-blocking door is closed; and
(d) opening said second light-blocking door only when said second light-blocking door is closed.

3. The method for cultivating photoperiodic plants as recited in claim 2, comprising:
(a) providing said second wall with a third light-blocking door;
(b) providing said first wall with a fourth light-blocking door;
(c) opening said third light-blocking door only when said fourth light-blocking door is closed; and
(d) opening said fourth light-blocking door only when said third light-blocking door is closed.

4. The method for cultivating photoperiodic plants as recited in claim 3, comprising:
(a) wherein said conveyor system is provided in a loop extending from said day room, through said first light-blocking door, through said control area, through said second light-blocking door, through said night room, through said third light-blocking door, back through said control area, through said fourth light-blocking door, and back into said day room; and
(b) operating said conveyor system to circulate each of said plant racks around said loop, thereby providing said periodic day phase and night phase for each of said plant racks.

5. The method for cultivating photoperiodic plants as recited in claim 4, comprising providing a third wall connecting said first wall to said second wall, said third wall having a first end lying between said second door and said third door, and said third wall having a second end lying between said first door and said fourth door.

6. The method for cultivating photoperiodic plants as recited in claim 1, comprising:
(a) wherein said conveyor system is provided in a loop extending from said day room, through said control area, through said night room, back through said control area, and back into said day room; and
(b) operating said conveyor system to circulate each of said plant racks around said loop, thereby providing said periodic day phase and night phase for each of said plant racks.

7. The method for cultivating photoperiodic plants as recited in claim 2, comprising:
(a) wherein said conveyor system is provided in a loop extending from said day room, through said control area, through said night room, back through said control area, and back into said day room; and
(b) operating said conveyor system to circulate each of said plant racks around said loop, thereby providing said periodic day phase and night phase for each of said plant racks.

8. A method for cultivating photoperiodic plants needing a day phase and a night phase, comprising:
(a) providing a day room that is continually light;
(b) providing a night room that is continually dark;
(c) providing a control area between said day room and said night room, said control area including a first light-blocking door;
(d) providing a plurality of plant racks, with each plant rack containing some of said plants;
(e) providing a conveyor system configured to move said plant racks from said day room, through said control area, into said night room, back through said control area, and into said day room again; and
(f) using said conveyor system to move said plant racks from said day room to said night room and back again according to a schedule configured to provide said desired day phase and night phase for said plants.

9. The method for cultivating photoperiodic plants as recited in claim 8, comprising:
(a) providing said control area with a first wall separating said control area from said day room, said first wall having said first light-blocking door;
(b) providing said control area with a second wall separating said control area from said night room, said second wall having a second light-blocking door;
(c) opening said first light-blocking door only when said second light-blocking door is closed; and
(d) opening said second light-blocking door only when said second light-blocking door is closed.

10. The method for cultivating photoperiodic plants as recited in claim 9, comprising:
(a) providing said second wall with a third light-blocking door;
(b) providing said first wall with a fourth light-blocking door;
(c) opening said third light-blocking door only when said fourth light-blocking door is closed; and
(d) opening said fourth light-blocking door only when said third light-blocking door is closed.

11. The method for cultivating photoperiodic plants as recited in claim 10, comprising:
(a) wherein said conveyor system is provided in a loop extending from said day room, through said first light-blocking door, through said control room, through said second light-blocking door, through said night room, through said third light-blocking door, back through said control room, through said fourth light-blocking door, and back into said day room; and
(b) operating said conveyor system to circulate each of said plant racks around said loop, thereby providing said periodic day phase and night phase for each of said plant racks.

12. The method for cultivating photoperiodic plants as recited in claim 11, comprising providing a third wall connecting said first wall to said second wall, said third wall having a first end lying between said second door and said third door, and said third wall having a second end lying between said first door and said fourth door.

13. The method for cultivating photoperiodic plants as recited in claim 8, comprising:
(a) wherein said conveyor system is provided in a loop extending from said day room, through said control area, through said night room, back through said control area, and back into said day room; and
(b) operating said conveyor system to circulate each of said plant racks around said loop, thereby providing said periodic day phase and night phase for each of said plant racks.

14. The method for cultivating photoperiodic plants as recited in claim 9, comprising:
(a) wherein said conveyor system is provided in a loop extending from said day room, through said control area, through said night room, back through said control area, and back into said day room; and
(b) operating said conveyor system to circulate each of said plant racks around said loop, thereby providing said periodic day phase and night phase for each of said plant racks.

15. A method for cultivating photoperiodic plants needing a day phase and a night phase, comprising:
(a) providing a day room that is continually light;
(b) providing a night room that is continually dark;
(c) providing a control area between said day room and said night room, said control area including a first light-blocking door;
(d) providing a plurality of said photoperiodic plants;
(e) providing a conveyor system configured to move said plants from said day room, through said control area, into said night room, back through said control area, and into said day room again; and
(f) using said conveyor system to move said plants from said day room to said night room and back again according to a schedule configured to provide said desired day phase and night phase for said plants.

16. The method for cultivating photoperiodic plants as recited in claim 15, comprising:
(a) providing said control area with a first wall separating said control area from said day room, said first wall having said first light-blocking door;
(b) providing said control area with a second wall separating said control area from said night room, said second wall having a second light-blocking door;
(c) opening said first light-blocking door only when said second light-blocking door is closed; and
(d) opening said second light-blocking door only when said second light-blocking door is closed.

17. The method for cultivating photoperiodic plants as recited in claim 16, comprising:
(a) providing said second wall with a third light-blocking door;
(b) providing said first wall with a fourth light-blocking door;
(c) opening said third light-blocking door only when said fourth light-blocking door is closed; and
(d) opening said fourth light-blocking door only when said third light-blocking door is closed.

18. The method for cultivating photoperiodic plants as recited in claim 17, comprising:
(a) wherein said conveyor system is provided in a loop extending from said day room, through said first light-blocking door, through said control room, through said second light-blocking door, through said night room, through said third light-blocking door, back through said control room, through said fourth light-blocking door, and back into said day room; and
(b) operating said conveyor system to circulate each of said plants around said loop, thereby providing said periodic day phase and night phase for each of said plants.

19. The method for cultivating photoperiodic plants as recited in claim 18, comprising providing a third wall connecting said first wall to said second wall, said third wall having a first end lying between said second door and said third door, and said third wall having a second end lying between said first door and said fourth door.

20. The method for cultivating photoperiodic plants as recited in claim 15, comprising:
(a) wherein said conveyor system is provided in a loop extending from said day room, through said control area, through said night room, back through said control area, and back into said day room; and
(b) operating said conveyor system to circulate each of said plants around said loop, thereby providing said periodic day phase and night phase for each of said plants.
